(19) United States
(12) Patent Application Publication
(10) Pub. No.: US 2024/0227094 A9
(43) Pub. Date: Jul. 11, 2024

(54) PULLEY AND GEAR REMOVER

(71) Applicant: Todd Brangers, Louisville, KY (US)

(72) Inventor: Todd Brangers, Louisville, KY (US)

(21) Appl. No.: 18/488,302

(22) Filed: Oct. 17, 2023

Related U.S. Application Data
(60) Provisional application No. 63/380,810, filed on Oct. 25, 2022.

(51) Int. Cl. B23P 19/02

(52) U.S. Cl. CPC B23P 19/025

(57) ABSTRACT

Aspects of the present disclosure deal with a tool for removing shaft components from a shaft. In one embodiment, the tool is a shaft component separator with an inflatable bladder configured to wrap circumferentially around a shaft. In one embodiment, the bladder is slotted to form a C-shaped profile so that a user can position the bladder perpendicularly around the shaft, adjacent a removable shaft component. Extending from the bladder is an inflation stem, which enables the user to move the ring between a deflated state and an inflated state via the introduction and/or removal of a fluid. Typically, the user positions the bladder between a fixed component and the removable shaft component, such that the fixed component and removable shaft component form a sandwich arrangement with respect to the bladder. Expansion of the bladder, via fluidic pressure, applies increasing axial force to the removable shaft component until the removable shaft component breaks free from the shaft.

### FIELD OF THE DISCLOSURE

Aspects of the present invention deal with devices for removing components from a shaft and more particularly pertain to devices using pneumatic pressure to remove components from a shaft.

### BACKGROUND

Removal of shaft components, such as pulleys, gears, and/or bearings from a shaft is often a difficult and laborious process, especially if the parts are corroded, rusted, or jammed together. Typically, corroded and/or press fit type shaft components are removed via a threaded bearing/gear puller. However, these gear pullers commonly damage the removed shaft component and may damage the shaft, which increases maintenance costs. In other examples, the gear puller is unable to remove stuck shaft components from the shaft. In these cases, a user cuts the shaft component off of the shaft, which can cause damage to the shaft.

There is a need for improvement in this field.

### SUMMARY

Embodiments of the present disclosure include a device or tool for pneumatically removing shaft components, such as gears, bearings, and/or pulleys, from a shaft. In one embodiment, the tool is a shaft component separator with an inflatable bladder. In one example, the bladder is ring or C-shaped and slotted to enable a user to position the bladder around a shaft.

In one example, a flat, deflated bladder forming a sealed chamber is placed circumferentially around a shaft and perpendicular to the shaft, such as a motor shaft, adjacent a shaft component to be removed. The bladder is adjustable between a deflated condition and an inflated condition via the introduction or removal of a fluid from the bladder. Typically, the deflated bladder is inserted between a face of the motor or other fixed component and a face of the shaft component, preferably with limited spacing between the components. The fixed component face and the shaft component face form a sandwich arrangement on opposing sides of the bladder. The bladder typically is formed of an inflatable material such as a flexible rubber. The bladder forms a sealed chamber that is configured to receive and/or contain a fluid. According to one example, the bladder includes a ring or C-shaped profile, wherein the bladder is curved and extends to a pair of ends with a slot defined between the ends. the ring or C-shaped bladder defines a central opening exterior to the sealed chamber. The central opening is in communication with the slot so that a user can position the bladder by advancing it perpendicularly around the shaft so that it encircles the shaft without the need to slide the bladder along the length of the shaft. According to one example, the external diameter of the bladder is sized and selected to correspond with a diameter of the shaft component to be removed. In another example, the external diameter may be larger and/or smaller than the component to be removed.

A hollow stem extends outward from the bladder. The stem is configured to enable a user to inflate and/or deflate the bladder via introducing and/removing fluid to or from the sealed chamber via the stem. The fluid is typically a gas or a liquid, which produces pneumatic and/or hydraulic pressure in the sealed chamber of the bladder. According to certain embodiments, the stem includes a valve, such as a regulator, configured to facilitate the flow of the fluid into and/or out of the bladder. In one example, the user may connect the stem to an air compressor to inflate the bladder. In another example, the user may connect the stem to a pump, such as a manual pump, to inflate the bladder. As should be appreciated, the bladder is adjustable between a deflated, flat state and an inflated, tubular state via the introduction and/or removal of the fluid. In another embodiment, the tool optionally includes at least one shim configured to be placed adjacent the deflated bladder on the shaft to fill space between the bladder and a removable shaft component and a fixed component. The shim includes a C-shaped profile complimentary to the bladder, wherein the shim is curved and extends to a pair of ends with a slot defined between the ends. The shim includes a central opening to encircle the shaft. The central opening is in communication with the slot so that a user can position the shim perpendicularly around the shaft without the need to slide the shim along the length of the shaft.

In one use case, the bladder, in the flat, deflated position, is inserted perpendicular to the shaft, between the fixed component face and the shaft component face. Optionally in some examples, one or more shims may be inserted perpendicular to a shaft adjacent the bladder to “close the gap” between the fixed component and shaft component. The bladder is adjusted into the inflated position via the introduction of the fluid. As fluid is added to the sealed chamber of the bladder, the bladder expands, thus filling the gap between the fixed component and the shaft component. As the bladder continues to expand, an increasing axial force is applied evenly in a circle around the shaft diameter to the face of the shaft component until the component breaks loose and/or releases from the shaft. As should be appreciated, this method facilitates removal of shaft components via a smooth, gradually increasing, balanced force application, which reduces the risk of costly damage to the shaft and/or components caused by prying and/or inconsistent force application. Other objects and attendant advantages will be readily appreciated, as the same become better understood by reference to the following detailed description when considered in connection with the accompanying drawings.

### BRIEF DESCRIPTION OF THE DRAWINGS

FIG. 1 is a perspective view of a shaft component separator according to an embodiment of the present disclosure.

FIG. 2 is a rear perspective view of the shaft component separator of FIG. 1.

FIG. 3 is a top view of the shaft component separator of FIG. 1.

FIG. 4 is a side view of the shaft component separator of FIG. 1 in a deflated state.

FIG. 5 is a side view of the shaft component separator of FIG. 1 in an inflated state.

FIG. 6 is a cross-sectional view of the shaft component separator of FIG. 1.

FIG. 7 is an alternate cross-sectional view of the shaft component separator of FIG. 1.

FIG. 8 is a diagrammatic view of the shaft component separator, positioned around a shaft, when in the deflated state shown in FIG. 4

FIG. 9 is a diagrammatic view of the shaft component separator, positioned around the shaft, when in the inflated state shown in FIG. 5.

FIG. 10 is a top view of the shaft component separator according to an embodiment of the present disclosure.

### DESCRIPTION OF THE ILLUSTRATED EMBODIMENTS

For the purposes of promoting an understanding of the principles of the disclosure, reference will now be made to the embodiments illustrated and specific language will be used to describe the same. It will nevertheless be understood that no limitation of the scope of the disclosure is thereby intended, such alterations, modifications, and further applications of the principles being contemplated as would normally occur to one skilled in the art to which the disclosure relates.

Embodiments of the present disclosure include a tool for pneumatically removing shaft components, such as gears, bearings, and/or pulleys, from a shaft. In one embodiment, the tool is a shaft component separator with an inflatable bladder. In one example, the bladder is ring or C-shaped and slotted to enable a user to position the bladder around a shaft.

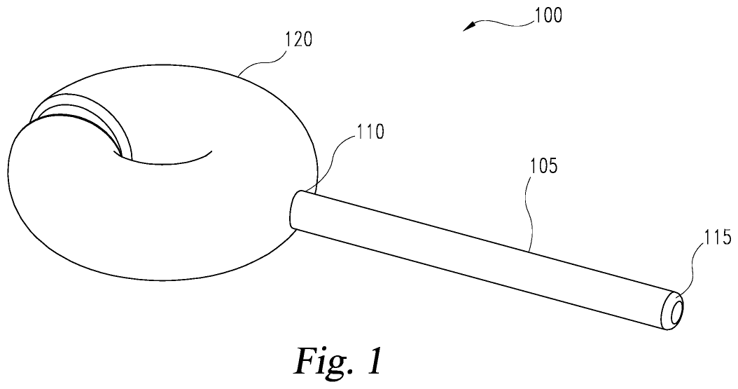

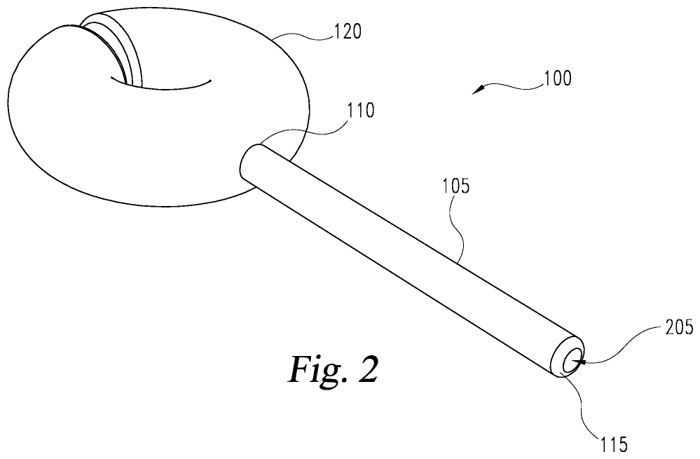

FIGS. 1 and 2 illustrate examples of a tool in the form of a shaft component separator 100. In the illustrated embodiments, the shaft component separator 100 includes an inflation stem 105 with a first end 110 and a second end 115. Located at the first end 110 of the inflation stem 105 is an bladder 120 forming a sealed chamber. The bladder 120 is sized to be positioned to surround a shaft, such as a motor shaft. In one embodiment, the bladder 120 transitions from a deflated (flat) state to an inflated (tubular) state via the introduction and/or removal of a fluid. As shown in FIG. 2, the inflation stem 105 includes an aperture 205 located at the second end 115 of the inflation stem 105. The aperture 205 allows a user to introduce and/or remove fluid to and/or from the sealed chamber of the bladder 120.

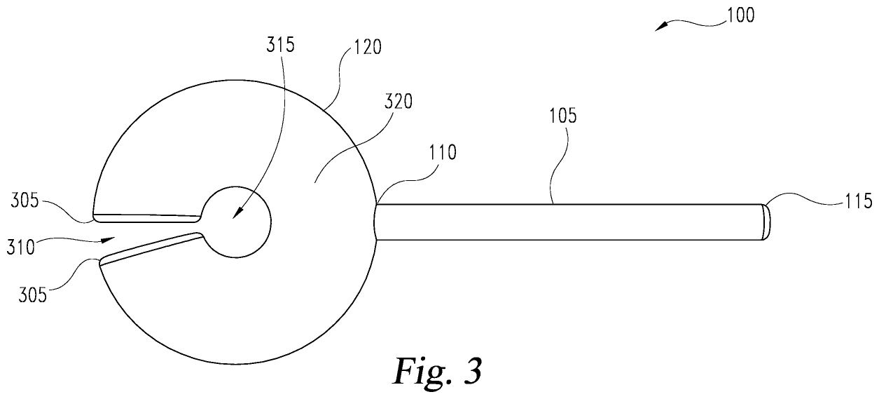

FIG. 3 illustrates a top view of the shaft component separator 100 according to one embodiment. In the illustrated embodiment, the bladder 120 defines a ring or C-shape. The bladder is made from an inflatable material forming a sealed chamber which is not permeable to fluids, such as an elastic rubber. In less preferred embodiments, the bladder may be shaped as an oval or polygon such as a rectangle. In the C-shaped embodiment, the bladder 120 includes a pair of ends 305 defining opposing ends of the bladder 120. In one example, the ends 305 define the exterior bounds of a slot 310, which enables a user to slide the shaft component separator 100 into position around and perpendicular to the shaft, without removing components from the shaft. The slot 310 extends into and communicates with a central opening 315 which is exterior to the sealed chamber and sized to extend circumferentially around the shaft. The bladder 120 further includes a pair of opposing faces 320 extending in the plane of the bladder 120. The faces 320 may include a front face and a back face opposite the front face. The faces 320 extend perpendicular to the shaft when the bladder is positioned around the shaft. The faces 320 are arranged to contact one or more shaft components during a removal process, namely a removable shaft component and a fixed shaft component. For instance, when the bladder is inflated, the faces 320 contact and apply axial force to the shaft components, to move the removable shaft component away from the fixed component along the shaft. The axial force is evenly distributed around the face and applies a balanced force to the removable shaft component.

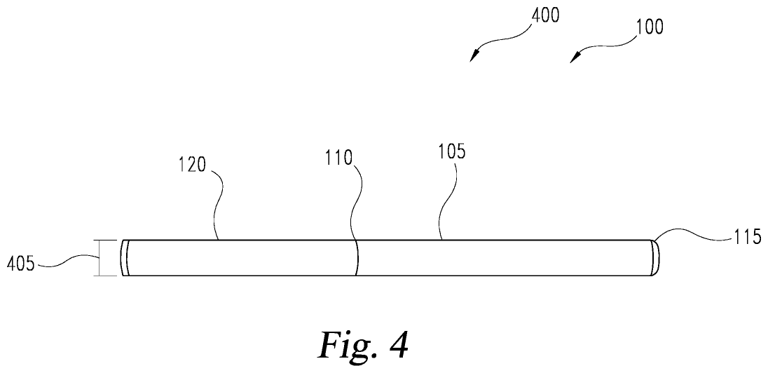

FIG. 4 shows a side view of the shaft component separator 100 in a deflated state 400. In the deflated state 400, the bladder 120 defines a first thickness 405. In the first thickness 405, the bladder 120 is substantially flat. As should be appreciated, the reduced thickness of the bladder 120 in the deflated state 400 allows a user to insert the bladder 120 between close-fitting shaft components. Optionally, the bladder may have a cover or may be positioned within a flexible protective sheath or cover to protect the material forming the sealed chamber.

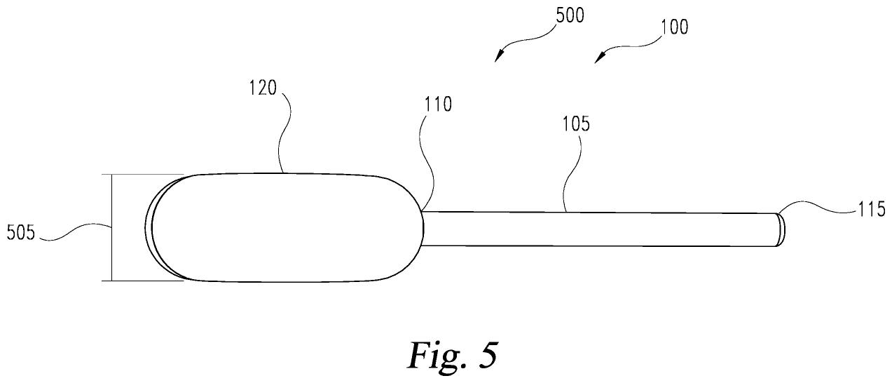

FIG. 5 shows a side view of the shaft component separator 100 in an inflated state 500. In the inflated state 500, the bladder 120 defines a second thickness 505. In the second thickness 505, the bladder 120 is substantially tubular. The second thickness 505 is larger than the first thickness 405 discussed previously. For example, the second thickness 505 may be double, triple, quadruple, and/or any other number of times larger than the first thickness 405, within the tolerance of the inflatable material. As should be appreciated, the shaft component separator 100 moves from the first thickness 405 to the second thickness 505 via the addition of fluid into the bladder 120 via the inflation stem 105. In one embodiment, the thickness of the bladder 120 in the inflated state 500 is variable based on the volume of fluid added to the bladder 120. Thus, the second thickness 505 of the bladder 120 is able to accommodate different opening sizes between shaft components. The bladder thickness may also be incrementally adjusted via the gradual addition or removal of fluid.

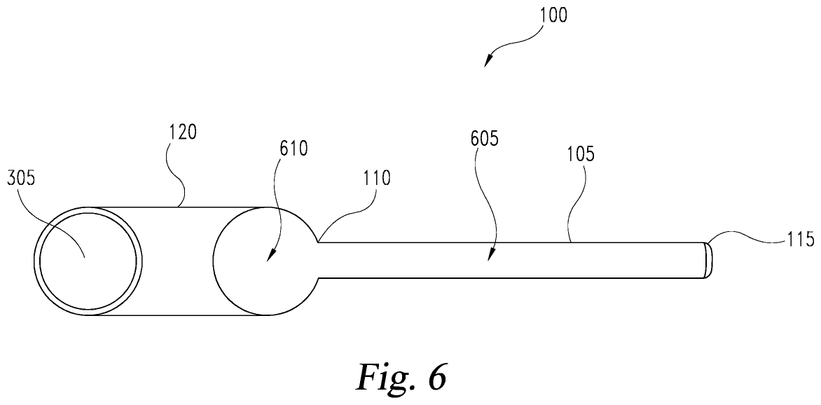

FIG. 6 illustrates a vertical cross section of the shaft component separator 100. In the illustrated embodiment, the inflation stem 105 has a hollow core 605. The core 605 directs a fluid flowing through the inflation stem 105 into the sealed chamber 610 of the bladder 120. As should be appreciated, various fluids may be used to fill and/or expand the bladder 120, such as gasses and/or liquids. Ambient air is commonly used. In one example, the fluid used to fill the bladder 120 is supplied via a pump, air compressor, and/or other device. The stem 105 may include a valve, such as a regulator, a check valve, manual valve, ball valve, and/or other form of valve configured to facilitate the flow of the fluid into and/or out of the sealed chamber 610.

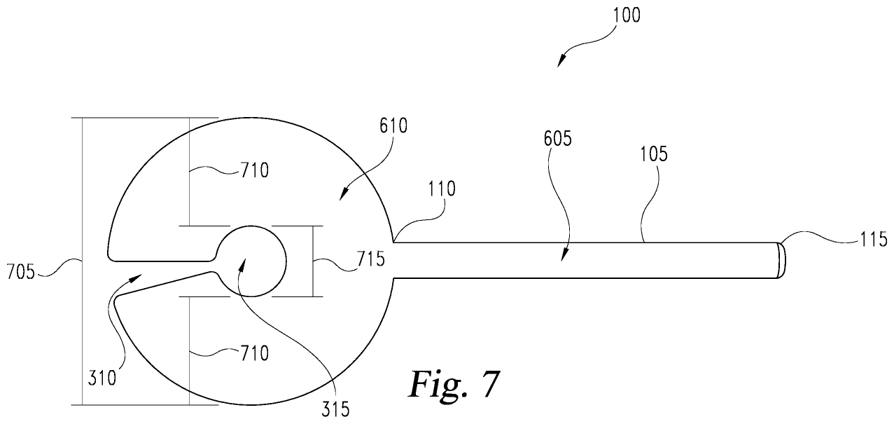

FIG. 7 shows a horizontal cross section of the shaft component separator 100. In the illustrated embodiment, the bladder 120 defines an external diameter 705. The external diameter 705 is formed via a pair of sidewall thicknesses 710 and an opening diameter 715. The sidewall thicknesses 710 correspond to a portion of the surface area of the faces 320 mentioned previously. For example, a larger sidewall thickness 710 correlates to a larger surface area for the faces 320. The opening diameter 715 is the diameter of the opening 315. The opening diameter 715 is typically selected and sized according to a diameter of the shaft containing the removable shaft components. For example, an opening diameter 715 of about two (2) inches may be used with a shaft having a two (2) inch diameter. In another example, the opening diameter 715 may be larger and/or smaller than the shaft diameter.

The external diameter 705 is preferably sized to be complimentary to an exterior diameter of the removable shaft component and/or the fixed component in order to maximize force transfer between the faces 320 of the bladder 120, the fixed component and the removable shaft component. Thus, an external diameter 705 of about six (6) inches may be used with a component diameter of six (6) inches. If the fixed component and the removable shaft component are of different sizes, the external diameter may be sized to more closely compliment the smaller component, to maximize the axial contact area. In less preferred examples, the external diameter 705 may be larger and/or smaller than the component to be removed. As should be appreciated, various external diameters 705 and opening diameters 715 may be used with different shaft and/or component diameters. For example, the external diameter 705 and the opening diameter 715 may be larger and/or smaller than the component and/or shaft diameter.

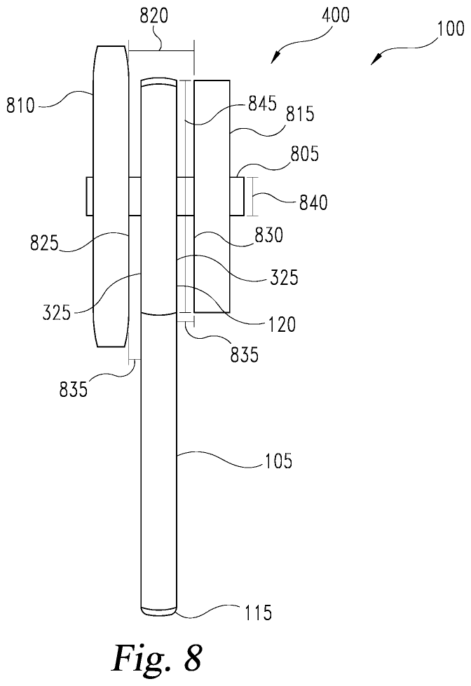

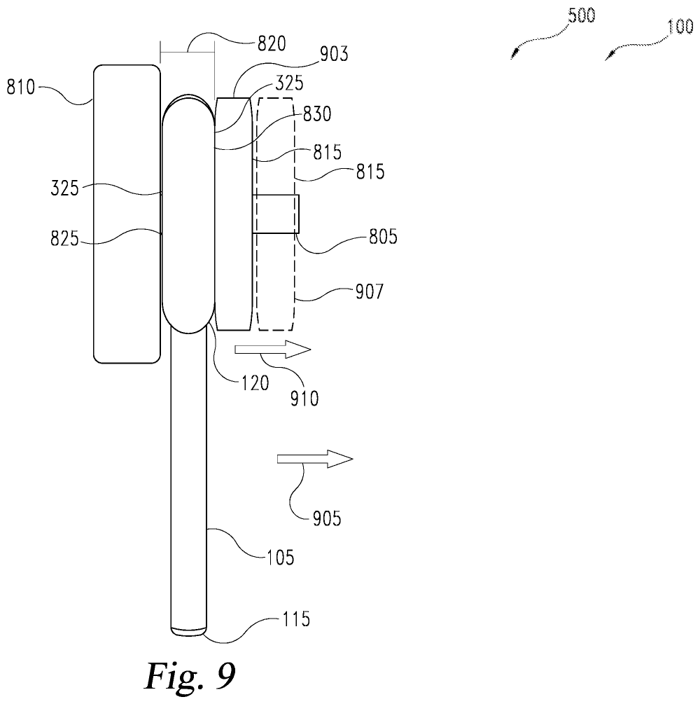

FIGS. 8 and 9 show examples of the shaft component separator 100 in use. As shown in FIG. 8, the shaft component separator 100 is positioned around a shaft 805 in the deflated state 400. In the illustrated embodiment, the bladder 120 is positioned between a fixed component 810, such as a motor, and a removable shaft component 815, such as a gear, pulley, and/or bearing. Put differently, the fixed component 810 and the removable shaft component 815 form a sandwich arrangement with respect to the bladder 120. The fixed component 810 and the removable shaft component 815 define a space 820 between a face 825 of the fixed component 810 and a face 830 of the removable shaft component 815. The bladder 120 is positioned around the shaft 805, within the space 820, via the slot 310. In one example, the bladder 120 forms a pair of gaps 835 between the faces 320 of the bladder 120 and the face 825 of the fixed component 810 and the face 830 of the removable shaft component 815. In some embodiments, at least one shim (not shown for ease of illustration) may be inserted between the fixed component 810 and the removable shaft component 815 to partially and/or fully fill the gaps 835. The shim includes a C-shaped profile, wherein the shim is curved and extends to a pair of ends with a slot defined between the ends. The shim includes a central opening. The central opening is in communication with the slot so that a user can position the shim perpendicularly around the shaft without the need to slide the shim along the length of the shaft. In one preferred embodiment, the diameter of the shim equals the external diameter 705 of the bladder 120, and the diameter of the central opening of the shim equals the diameter of the opening 315 of the bladder 120. In another example, the bladder 120 fully fills or substantially fills the space 820 such that no noticeable gaps 835 are present.

As mentioned previously, the shaft 805 has a shaft diameter 840, which preferably approximately corresponds to an opening diameter 715 of the bladder 120. Similarly, the removable shaft component 815 has an exterior diameter 845, which preferably approximately corresponds to the external diameter 705 of the bladder 120. As examples, the removable shaft component 815 is a gear, pulley, bearing, and/or other shaft component.

FIG. 9 illustrates the shaft component separator 100 in the inflated state 500. As described previously, the bladder 120 moves from the deflated state 400 to the inflated state 500 via introducing the fluid. The bladder 120 inflates until the faces 320 of the bladder 120 contact the face 825 of the fixed component 810 and the face 830 of the removable shaft component 815. Put differently, the bladder 120 inflates until the space 820 is filled by the bladder 120, with no gaps 835 remaining. To remove the removable shaft component 815, the bladder 120 inflates until an axial force is applied via the faces 320 of the bladder 320 and applies gradually increasing, balanced pressure until it preferably overcome the static force holding the removable shaft component 815 in position. The axial force is applied to the removable shaft component 815 in the direction shown by arrow 905 until the shaft component 815 breaks free from the shaft 805.

In the illustrated embodiment, the removable shaft component 815 moves from a first, stuck position 903 to a second, free position 907 via the application of the axial force by the shaft component separator 100 as shown by arrow 910. As should be appreciated, consistent application of an increasing axial force via the shaft component separator 100 results in smooth, gentle, and incremental removal of the removable shaft component 815 rather than erratic, rough, and inconsistent force application. Ideally, the shaft component 815 is removed from the shaft 805 without damage to the shaft 805 and/or the shaft component 815, which mitigates repair and/or replacement costs.

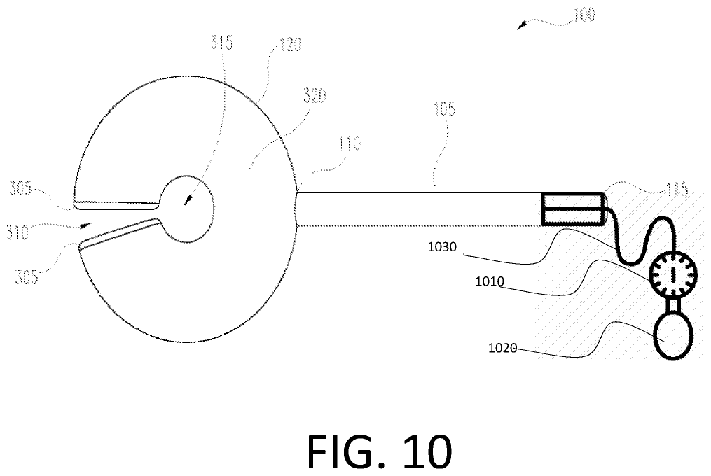

FIG. 10 illustrates a top view of the shaft component separator 100 with additional detail. As shown, the bladder 120 is coupled to the stem 105, which is further coupled to a regulator 1010 and a manual pump 1020. The regulator 1010 is configured with a valve that can be opened or shut to facilitate the flow of the fluid into and/or out of the sealed chamber 610. In some embodiments, a check valve is used. The manual pump 1020 is configured to facilitate the introduction of the fluid into the sealed chamber 610 via the regulator. In the illustrated example, the regulator 1010 is in communication with the stem 105 via a connecting tube 1130. The connecting tube 1130 extends from the regulator 1010 to the second end 115 of the stem 105. The connecting tube 1130 is configured to facilitate the fluid flow into and/or out of the sealed chamber 610.

While the disclosure has been illustrated and described in detail in the drawings and foregoing description, the same is to be considered as illustrative and not restrictive in character, it being understood that only the preferred embodiment has been shown and described and that all changes and modifications that come within the spirit of the disclosure are desired to be protected.

What is claimed:

1. A method for removing a removable shaft component from a shaft, comprising:
providing a bladder with a sealed chamber in a deflated condition, the bladder having a C-shaped curved body extending to a pair of ends with a slot defined between the ends, and wherein the bladder defines a central opening in communication with the slot;
inserting the bladder perpendicular to the shaft between a fixed component and a removable shaft component;
introducing a fluid to inflate the sealed chamber until the curved body contacts a face of a fixed component and a face of a removable shaft component, thereby applying axial force to the removable shaft component to move the removable shaft component away from the fixed component along the shaft.

2. The method of claim 1, wherein the axial force is evenly distributed around the face of the removable shaft component.

3. The method of claim 1, wherein the fluid source is an air compressor.

4. The method of claim 1, wherein the fluid source is a manual pump.

5. The method of claim 1, wherein the fluid is ambient air.

6. The method of claim 1, comprising
providing at least one shim having a C-shaped curved body extending to a pair of ends with a slot defined between the ends, and wherein the shim defines a central opening in communication with the slot; and
inserting the shim perpendicular to the shaft and adjacent to the bladder between the fixed component and the removable shaft component.

7. A method for removing a removable shaft component from a shaft, comprising:
providing a bladder with a sealed chamber in a deflated condition, the bladder defining a slot extending from the outer edge to a central opening in communication with the slot;
inserting the bladder perpendicular to the shaft between a fixed component and a removable shaft component;
introducing a fluid to inflate the sealed chamber until the curved body contacts a face of a fixed component and a face of a removable shaft component, thereby applying axial force to the removable shaft component to move the removable shaft component away from the fixed component along the shaft, wherein the axial force is evenly distributed around the face of the removable shaft component.

8. The method of claim 7, comprising incrementally increasing the axial force applied to the removable shaft component to move the removable shaft component away from the fixed component along the shaft.

9. The method of claim 7, wherein the axial force is evenly distributed around the face of the removable shaft component.

10. The method of claim 7, wherein the fluid source is an air compressor.

11. The method of claim 7, wherein the fluid source is a manual pump.

12. The method of claim 7, wherein the fluid is ambient air.

13. The method of claim 7, comprising inserting the shim perpendicular to the shaft and adjacent to the bladder between the fixed component and the removable shaft component.

14. A tool for removing a removable shaft component from a shaft, comprising:
a bladder formed of an inflatable material forming a sealed chamber;
the bladder defining a slot extending from an exterior edge to a central opening exterior to the sealed chamber;
wherein the bladder is adjustable between a deflated condition and an inflated condition via the introduction or removal of a fluid from the bladder;
a hollow stem having an end coupled to the sealed chamber for introducing or removing the fluid from the bladder;
wherein the bladder is sized in the deflated condition to be introduced perpendicular to a shaft between a removable shaft component and a fixed component, wherein the slot passes over the shaft, so that the shaft is encircled by the central opening; and
wherein inflating the bladder to the inflated condition applies force to the removable shaft component to move the removable shaft component away from the fixed component along the shaft.

15. The tool of claim 14, wherein the bladder has a C-shaped profile, wherein the bladder includes a curved body extending to a pair of ends with the slot defined between the ends.

16. The tool of claim 14, further comprising at least one shim wherein the shim is sized to be introduced perpendicular to a shaft adjacent the bladder between a removable shaft component and a fixed component.

17. The tool of claim 15, wherein the shim has a C-shaped profile, wherein the shim includes a curved body extending to a pair of ends with a slot defined between the ends and wherein the shim defines a central opening in communication with the slot.

18. The tool of claim 14, further comprising a valve coupled to the stem and configured to control the flow of fluid into and out of the sealed chamber.

19. The tool of claim 4 wherein the regulator is coupled to an air compressor.

20. The tool of claim 5 wherein the pump includes a manual pump.
